(19) United States
(12) Patent Application Publication
(10) Pub. No.: US 2012/0296844 A1
(43) Pub. Date: Nov. 22, 2012

(54) Method for Creating Roll Yield Indexes and Index Products

(75) Inventors: Stuart J. Rosenthal, Cranford, NJ (US); William J. Smalley, New York, NY (US); Robert Stanley Tull, Levittown, PA (US); Richard W. Roll, Culver City, CA (US)

(73) Assignee: Factor Advisors, LLC, New York, NY (US)

(21) Appl. No.: 13/334,465

(22) Filed: Dec. 22, 2011

Related U.S. Application Data
(60) Provisional application No. 61/426,574, filed on Dec. 23, 2010.

(51) Int. Cl. G06Q 40/06

(52) U.S. Cl. 705/36 R

(57) ABSTRACT

An inventive computerized investment method and process is disclosed that comprises the creation, calculation, and use of a “Roll Yield” Index, which is a function of a futures contract “rolling” methodology that may vary depending on the underlying commodity, and a systematic rebalancing mechanism for portfolio management of long/short commodity futures index products. Both the Roll Yield Index and the long/short portfolios have the same investment objective to deliver the spread, or difference, between two or more futures contracts on the same underlying commodity with different expiration dates.

### RELATED APPLICATION

This application claims the benefit of priority to U.S. Provisional Patent Application Ser. No. 61/426,574, filed on Dec. 23, 2010, the contents of which are incorporated into this application by reference.

### TECHNICAL FIELD

The present invention relates generally to investment methodologies and processes, and more particularly, to computerized methods for creating indexes that use a futures contract “rolling” methodology to calculate the yield in excess of implied financing costs, and a systematic rebalancing methodology for portfolio management of long/short commodity futures index products. The inventive methodology may vary depending on the underlying commodity at issue.

### BACKGROUND OF THE INVENTION

Future contracts, as traded on future exchanges globally, are a means for near-term price discovery for many different asset classes. Example asset classes include equities, energy, industrial metals, bullion, agricultural commodities, currencies, interest rates, real estate and many other asset classes, including solely by way of example, weather and carbon.

Common to all future contracts is the short-term nature of liquidity. Most of the future's liquidity is concentrated in the first three contract months. Contract periods often extend out for years but are typically not actively traded, but priced according to the futures curve through switch markets between the near-term pricing curve and negotiation fixed price differences as opposed to outright price making.

“Backwardation” is the name for the condition that the market quotes a lower price for a more distant delivery dated future contracts and a higher price for a nearby delivery date. When future contracts are greater in the forward months and lesser in the near-term future contracts the futures are said to be in “contango.” “Contango” and “backwardation” in futures are said to comprise the “futures curve.”

The backwardation curve reflects current market demand for immediate product delivery or exposure. When the curve reflects future demands it is a called a contango curve. It is instructive to note that a single futures contract curve can reflect both backwardation and contango at various time periods along the entire curve of future prices.

When a futures market is in contango, the contango has an implied yield for any two points along the curve of increasing future prices. The yield can reflect carry or financing cost of cash delivery ownership (purchase the asset and fund the purchase into the future) and/or storage costs between the current delivery month and the future contract first delivery date, as well as demand. However in backwardation periods the current demand for the commodity is the dominant market force and storage and financing costs are not important in the futures pricing curve.

The contango yield is not always equivalent to the treasury yield because contango may also reflect the costs of storage, insurance, transportation, delivery location and a host of other factors that are related to physical commodities and attributes. A good example of this are Western Texas Intermediate (“WTI”) oil prices where the physical delivery of the product requires the equivalent of delivery at Cushing, Okla., being a major pipeline hub. The delivery at Cushing may also include pipeline transportation and water vapor content tests on the crude oil deliveries from anywhere in the pipeline system. As such, all, or none of these charges, maybe be reflected in a futures contango as well as the financing cost associated with the purchase of the cash commodity and the forward delivery month.

The idea of the contango yield is to permit investors to capture the implied costs included in commodity prices, above financing costs, in order to earn the implied excess interest rate yield or the “Roll Yield.” In turn, Roll Yield Indexes focus on commodity yield curves and seek to find yields that are in excess of the implied financing costs which would capture the excess demand as reflected in the yield. This excess demand is often reflected in the near-term price curve and is captured through the sale of a steep contango futures and the purchase of a less steep contango futures. As the majority of futures liquidity is focused in the first three near-term contracts, the Roll Yield Index will often sell the spot or spot next futures, and purchase the spot second next futures. However, the Roll Yield Index is not constrained to any specific contracts of the yield curve and can find opportunity along the entire yield curve of the commodity.

Other methods and processes have attempted to address this problem. By way of example, U.S. Pat. No. 7,958,033 (the “'033 patent”) discloses a method for building a commodity index which measures liquidity of expiring commodity future contracts to the liquidity of the spot next contract in order to determine when to “roll” the futures contract. By contrast, the present invention does not measure liquidity in order to determine when to roll a futures contract. The present invention teaches the creation of a roll yield index, and accordingly, focuses on the selection of commodities to be included in the index which is in contango and has sufficient liquidity to support the roll yield formula methodology.

Neither U.S. patent application Ser. Nos. 09/764,574 nor 09/829,529 teach or disclose roll yield strategies or analyses. The '574 application discloses trading commodities using a computer driven model, while the '529 application teaches the creation of a commodities trading platform, for plastic polymer futures.

Similarly, U.S. Pat. No. 7,739,186 (the “'186 patent”) teaches the creation of a commodity based exchange traded fund (“ETF”) limited to long oil contracts. As with the above patent and patent applications, the '186 patent does not disclose or teach multiple long and short commodity positions, or the management of the contango and backwardation exposure as part of the investment premium. More specifically, the '186 patent appears to focus gaining exposure to oil.

In the disclosed preferred embodiments, the present invention addresses and solves the problem of finding and capturing the yields that are in excess of the implied financing costs and thereby capture the excess demand as reflected in the yield. Prior art methods and processes have not disclosed or achieved such results.

### BRIEF SUMMARY OF THE INVENTION

According to a preferred embodiment of the present invention, a method to design and create real time Roll Yield Indexes (“RYIs”), and rebalance said RYIs is disclosed, comprising a computer processor, a computer memory database, real time commodity price feed information, wherein the RYI is calculated using an algorithm that provides a total return index measuring a weighted-average commodity futures basket, where the product of the base index level and the weighted-sum of the periodic returns of the basket's components equals the periodic excess return; and the RYI is rebalanced periodically using an algorithm that isolates the percentage difference in performance, between a first futures contract and a second futures contract at predetermined time periods, and automatically adjusts the long and short positions of the futures contracts for dollar-neutrality at the beginning of every predetermined time period.

Another preferred embodiment of the present invention is a computerized investment method to create on a real time basis, Roll Yield Indexes (“RYI”), and to rebalance on a periodic basis the RYI, comprising a computer processor; a computer memory database; and real time commodity price feed information; wherein the RYI is calculated using the following algorithm:

$$R Y {I}_{t , i} = R Y {I}_{t - 1 , i} + R Y {I}_{t - 1 , i} * {\sum }_{k = 1}^{{N}_{i}} ( {w}_{t - 1 , i , k} * \frac{{P}_{t , i , k}}{{P}_{t - 1 , i , k}} ) , t > 0$$

where RYI_{t,I}=Roll Yield Index for the ith commodity at time t; W_{t-1,i,k}=weight of the ith commodity at time t for contract k; P_{t,i,k}=price of the ith commodity at time t for contract k; and Nᵢ=number of contracts for commodity I; and further wherein the dollar-neutral net asset value (“NAV”) rebalancing of the RYI, on a “t” frequency for all t>0, is determined using the following algorithm:

NAVxyt*M*[1+(Xt+1÷Xt)−(Yt+1÷Yt)],NAVxyt+1*M*[1+(Xt+2÷Xt+1)−(Yt+2÷Yt+1)],NAVxyn*M*[1+(Xn÷Xn-1)−(Yn÷Yn-1)]

where Xt=absolute value of Index X at NAV calculation time t; Yt=absolute value of Index Y at NAV calculation time t; M=Multiplier or Leverage Factor, M< >0; NAVxyt=Net Asset Value of Long Short Portfolio XY at Time t; and “t” can be defined as 1 or more days (i.e., 2 days, 1 week, 1 month, or 1 year).

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is an overview flow diagram of the basic steps in an exemplary embodiment of the present invention for creating a roll yield index and then rebalancing the long/short commodity index futures products; and

FIG. 2 is a table of target weight of futures contracts determined as part of an exemplary embodiment of the present invention over a rolling nine day time period.

### DETAILED DESCRIPTION OF THE INVENTION

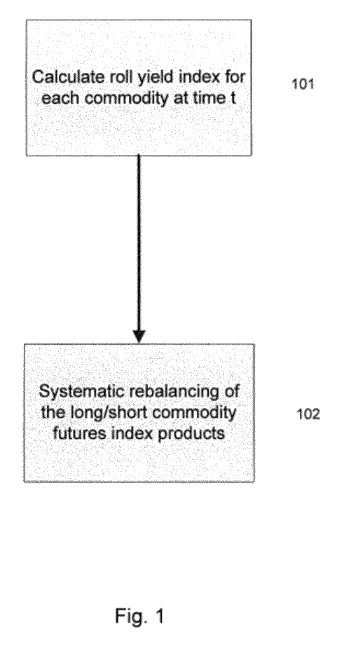

The inventive method comprises a process that combines, using a computer processor to (1) create and calculate on a real-time and an end of period basis, and the dissemination of, roll yield indexes that are a function of a futures contract methodology that may be a function of the underlying commodity, and (2) systematically rebalance the long/short commodity futures index, with the investment objective of delivering the difference, or spread, between two or more futures contracts on the same underlying commodity having different expiration dates. FIG. 1 illustrates this basis flow of calculating 101 the roll yield index and applying a systematic rebalancing 102 of the long/short commodity futures index to determine the spread.

A Roll Yield Index (“RYI”), as defined herein, represents an index design that will permit investors to measure the ability to capture positive yield returns from the futures curve for various points along the curve. When the yield between any two points along the futures curve has an implied yield, the RYI is designed to measure negative or positive interest rate returns for investors. The RYI may be used to build financial products based upon the opportunities that can be measured by the RYI. In preferred embodiments, the opportunities defined within the products/index representation present themselves in both contango and backwardation periods.

More particularly, the RYI is measured by the results of the following formula:

$$R Y {I}_{t , i} = R Y {I}_{t - 1 , i} + R Y {I}_{t - 1 , i} * {\sum }_{k = 1}^{{N}_{i}} ( {w}_{t - 1 , i , k} * \frac{{P}_{t , i , k}}{{P}_{t - 1 , i , k}} ) , t > 0$$

Where:
RYI_{t,I}=Roll Yield Index for the ith commodity at time t
w_{t-1,i,k}=weight of the ith commodity at time t for contract k
P_{t,i,k}=Price of the ith commodity at time t for contract k
Nᵢ=number of contracts for commodity i

The above formula represents a total return index measuring a weighted-average commodity futures basket, where the product of the base index level and the weighted-sum of periodic returns of the basket's components equals the periodic excess return. In preferred embodiments, the inventive method uses this weighted return algorithm along with a systematic change in components and component weights to capture excess return associated with “rolling” out of near-month commodity futures contracts (selling), and into futures contracts on the same underlying commodity but with a future-dated expiration that is embedded in commodity futures markets due to carry costs, physical delivery, and passively managed commodity index funds that must sell near-month futures as they approach expiration. This excess return is called the “Roll Yield.”

The inventive methodology comprises the creation, calculation, and dissemination of this index, which is contingent on a proprietary futures contract “rolling” methodology that may vary depending on the underlying commodity, and a systematic rebalance mechanism for portfolio management of long/short commodity futures index products. Both the Roll Yield Index and the long/short portfolios have the same investment objective—deliver the spread, or difference, between two or more futures contracts (on the same underlying commodity with different expirations). This Roll Yield Index methodology and systematic risk management for long/short portfolio products is based, in part, on the inventive methodology entitled “Method For Creating Factor Indexes And Long/Short Index Products with Systematic Risk Management” as described in detail in U.S. patent application Ser. No. 13/330,549. The description of the invention provided in the '549 application is incorporated by reference herein.

More particularly, the '549 application invention teaches, in part, a description of “Factor” investments providing returns from the creation of a long/short portfolio. As described in the '549 application:
Factor investments seek to isolate the risk premia, or Factor, of one market segment to another. In order to deliver these relative-value returns, one must simultaneously establish a long position in one market segment and a short position in another. Effectively, a Long/Short portfolio must be established. The portfolio is profitable when the long position outperforms the short position. The end-user, the investor, however, is not concerned with the implementation mechanics and maintenance of each individual component, but is instead interested only in capturing the performance of one versus the other. This investment objective can be simplified: a Factor investor seeks the difference between two market segments, or the return of one market segment minus the return of another market segment. By definition, this strategy has a spread objective.

For the present inventive method, the risk premia, as that term is used in the '549 application is the roll yield. The roll yield is based on a calendar spread strategy employed by a specific portfolio component weighting analysis that systematically rebalances long and short positions, in dollar-neutral proportions, as the underlying futures contracts approach expiration.

For real-time risk management, as intended in a preferred embodiment of the present invention, the process will include the continuous calculation of a proprietary futures contract “rolling” methodology that may vary depending on the underlying commodity, and include a systematic calculation or rebalancing mechanism for portfolio management of long/short commodity futures index products. This analysis and calculation relies upon a computer processor having sufficient capacity to capture necessary data, calculate the “rolling” methodology, and then store the roll yield index values to a computer memory database.

Determination of which contract is purchased (long) and which is sold (short) depends on the investment objective. In the context of roll yield products, this will depend on the shape of the futures curve. As described above, when a futures market is in “contango,” near-month contracts are cheaper than longer-dated contracts. Thus, in order to maintain a front-month futures position, an investor must sell out of the front-month contract before it expires and buy the second-month contract, which ultimately becomes the front-month contract after the aforementioned expiration date, because the investor does not want to take physical delivery of the commodity. When the futures market is in contango, the purchase of the same number of new contracts will cost more than what the front-month position can be sold for. This extra cost associated with rolling into new contracts represents a negative roll yield embedded in the term structure of the futures market.

In a preferred embodiment of the present invention, the method and process will measure the changes in roll yield, positive or negative, and deliver to investors excess returns via portfolio products. In contango markets, this can be achieved by establishing a short position in the front-month contract and a long position in a longer-dated contract. As the contango spread widens, the long/short portfolio (and Roll Yield Index) will increase. Similarly, if the difference between the prices of the two contracts declines, the excess return is negative and the portfolio (and accordingly the index) will decline. In this example, the application of the inventive method is designed for investors who are concerned that the magnitude of the contango will increase. In backwardated markets, where the price of front-month contracts is higher than those of the later months, the exact opposite situation exists, and there is a positive roll yield. Similarly, the investment strategy is reversed: a long position is established in the front-month contract and a simultaneous short position is established in the later contracts.

A critical component to the Roll Yield process is the weighting methodology, which systematically manages the “rolling” process as contracts approach expiration. Over a multi-period horizon, the portfolio will cover short exposure and sell long exposure, in accordance with dynamic target allocations. For example, in a contango (negative) roll yield capture Roll Yield product, the portfolio will buy front-month futures contracts to cover part of the short position and sell longer-dated futures contracts to reduce the long position. More particularly, the portfolio will sell/buy these contracts in order to rebalance the portfolio according to a target weight as specified by its Roll Yield Index. The fund equity that is made available due to the reduction of the short and long positions is then used to re-establish short and long positions futures contracts which expire in the next-closest month.

By way of specific example, in a preferred embodiment, a Roll Yield Index product targets the capture of excess roll yield in a futures market that is in contango. It establishes a short position in the front-month contract, K, and a simultaneous long position in the third-month contract, K+2. On day one of the roll period, a 9-day period defined by its Roll Yield Index methodology, this long/short portfolio covers 1/9^{th} of its short position (buys +11.11%×100% notional short exposure) in K futures and sells 1/9^{th} of its long position (sells 11.11%×100% notional long exposure) in K+2 futures. At the same time, the portfolio sells 11.11%×notional short exposure of the second-month contract, K+1, and buys 11.11% of notional long exposure of the fourth-month contract, K+3. Therefore, at the end of day 1 of the 9 day roll period, the short exposure consists of 88.89% short K contracts and 11.11% of short K+1 contracts, and the long exposure consists of 88.89% K+2 contracts and 11.11% K+3 contracts.

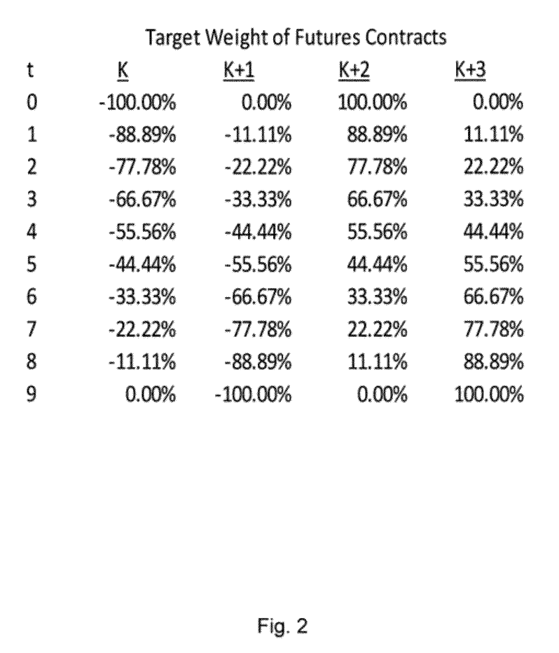

On Day 2, the long/short portfolio covers ⅛^{th} of the remaining short position in K futures and sells ⅛^{th} of the remaining long position in K+3 futures. In this example, ⅛^{th} of the +/−88.89% long/short exposure is equal to +/−11.11%. The +/−11.11% is reallocated to additional short K+1 futures and long K+3 futures. Therefore, during the roll period, the portfolio will buy and sell a notional amount equivalent to the reciprocal of the days remaining in the roll period. The table shown in FIG. 2 provides the calculated target portfolio allocation over the example 9-day roll period.

Accordingly, the Roll Yield Index is a two-fold, systematic risk management process. By automatically reallocating portfolio assets to further-dated futures contracts, the Roll Yield Index (and the long/short portfolio) ensures that the expiring front-month contracts are sold before expiration and that the portfolio is rebalanced back to dollar-neutrality to maintain the target spread investment objective.

In a preferred embodiment, the inventive process combines the calculation of Roll Yield Indexes and an automatic long/short portfolio risk management mechanism. The indexes establish a roll methodology (weighting analysis) and serve as the measurement, both real-time and end of period, of the roll yield (or risk premia) for both reference and investment product benchmarking purposes. The long/short portfolio that seeks to capture the roll yield uses the Roll Yield Indexes as a periodic target for reallocating fund equity in order to achieve their spread investment objectives (i.e., dollar-neutral, leveraged, excess negative/contango roll yield).

The particular algorithm used for rebalancing the investment product having a Roll Yield objective, in a preferred embodiment, is as follows.

### Let NAVxyₙ=Rebalanced Value of Dollar-Neutral Long/Short Portfolio, or

NAVxyₜ*M*[1+(Xₜ₊₁÷Xₜ)−(Yₜ₊₁÷Yₜ)]

where

Xₜ=absolute value of Long-Dated Futures Contracts X at NAV calculation time t

Yₜ=absolute value of Short-Dated Futures Contracts Y at NAV calculation time t

M=Multiplier, or Leverage Factor, M< >0

NAVxyₜ=Net Asset Value of Long Short Portfolio XY at Time t.

Then, for all t>0 in the arithmetic progression:

NAVxyₜ*M*[1+(Xₜ₊₁÷Xₜ)−(Yₜ₊₁÷Yₜ)],NAVxyₜ₊₁*M*[1+(Xₜ₊₂÷Xₜ₊₁)−(Yₜ₊₂÷Yₜ₊₁)], . . . NAVxyₙ*M*[1+(Xₙ÷Xₙ₋₁)−(Yₙ÷Yₙ₋₁)]

where “t” can be defined as 1 or more days (i.e., 2 days, 1 week, 1 month, 1 year, etc.), and where “e” is an intraday time frequency (for real-time computer calculation).

This algorithm defines the dollar-neutral net asset value (“NAY”) rebalance mechanism on a “t” time period frequency. Structurally, this algorithm may be used to isolate the risk premium, or percentage difference in performance, between Long-Dated Futures Contracts X and Long-Dated Futures Contracts Y for every t period, thereby automatically adjusting the long and short positions, as closely as possible, dollar-neutrality (netting positions) at the beginning of every t period. In RYI products, “Long-Dated Futures Contracts X” and “Short-Dated Futures Contracts Y” may include positions in more than one futures contract if considered during the roll period. End-users of RYI products based on the RYI ultimately measure performance this way—the difference between the weighted long-dated and the weighted short-dated futures contract positions.

The results of this algorithm and formula establish the index values over specific time periods along the futures curve. Moreover, using the algorithm, an investor's financial products may be built to take advantage of the time series data on these daily index levels. The index values may be used to anticipate back tested product performance, and the products will then capture this performance for investors. The normal product performance may be structured for future curves that are designed to capture contango markets. Inverse products may also be constructed for future curves that are in backwardation. For markets that exhibit both contango and backwardation markets, the products will be structured to perform well in contango periods and will lose money when the futures curves are in backwardation periods.

The financial products built to capture the performance of the Roll Yield Index will need to be rebalanced during their life. By way of example, the rebalance periods may be on a daily, weekly, monthly or quarterly basis depending on the futures curve of the benchmark commodities futures contract. Most financial products will be issued as dollar neutral strategies, but are not required to be so.

In a preferred embodiment, the products may be designed to capture the performance of the futures curve of the benchmark asset class. The products will often hold a future contract of the benchmark asset class, short-term fixed income investments, and may include cash positions in the asset class or related asset classes having a high correlation to the performance of the benchmark asset class. As provided above, the products will need to be rebalanced according to the roll periods of the underlying future contracts in order to capture the returns of the Roll Yield Index. The algorithm and process as described above, in Example 1, provides for the capture of the returns of the Roll Yield Index for relevant financial products.

For investors exposed to commodity future based investments, the investor may sell their long futures in the spot market and then purchase the next active futures contact in the same commodity. In contango markets, the investor sells current future holdings at a lower price and purchases next active futures at a higher price. The Roll Yield Product (“RYP”) will provide investors a means for offsetting this negative performance impact that is associated with future market. The contango RYPs are designed to purchase the lower priced spot futures when the commodity investor is selling their positions, and selling the futures to a commodity investor purchasing the next active futures at the higher price. This RYP value proposition is to reduce the negative impact of these two transactions such that the investor bears lower market impact costs from moving their exposure between the two future contracts, and realize a greater portion of the commodity market returns.

For future markets that are in backwardation, investors will realize positive returns from selling their spot future contacts at a higher price and purchasing the next active futures contract at a lower price. Generally no RYP product will be focused on future markets that remain in backwardation for extended periods of time. During market backwardation periods, investors will be able to enhance their returns by shorting the RYPs near the apex of the backwardation cycle, and purchasing the RYP when the backwardation cycle mean reverts to normal market averages.

For future market curves that are a combination of contango and backwardation, commodity investors could purchase the RYP when the market is in contango, and sell the RYP when the futures market enters a backwardation cycle. This will permit the investor to actively manage their expose to contango and backwardation cycles without selling exposure in the commodity index futures during varying market cycles.

A number of preferred embodiments of the invention have been described herein. It is to be understood that various modifications may be made without departing from the spirit and scope of the invention. By way of example only, although the embodiments have been described with reference to two commodity contracts, the inventive method and process is equally applicable to more than two commodity contracts. Accordingly, all such other embodiments are intended to be within the scope of the following claims.

What is claimed is:

1. A computerized investment method to design and create real time Roll Yield Indexes (“RYIs”), and rebalance said RYIs, comprising a computer processor, a computer memory database, real time commodity price feed information, wherein the RYI is calculated using an algorithm that provides a total return index measuring a weighted-average commodity futures basket, where the product of the base index level and the weighted-sum of the periodic returns of the basket's components equals the periodic excess return; and the RYI is rebalanced periodically using an algorithm that isolates the percentage difference in performance, between a first futures contract and a second futures contract at predetermined time periods, and automatically adjusts the long and short positions of the futures contracts for dollar-neutrality at the beginning of every predetermined time period.

2. The computerized investment method to design and create RYIs and rebalance said RYIs of claim 1, wherein the predetermined time period is 1 day.

3. The computerized investment method to design and create RYIs and rebalance said RYIs of claim 1, wherein the predetermined time period is 1 week.

4. The computerized investment method to design and create RYIs and rebalance said RYIs of claim 1, wherein the predetermined time period is 1 month.

5. The computerized investment method to design and create RYIs and rebalance said RYIs of claim 1, wherein the predetermined time period is 1 year.

6. The computerized investment method to design and create RYIs and rebalance said RYIs of claim 1, wherein the predetermined time period is greater than 1 year.

7. The computerized investment method to design and create RYIs and rebalance said RYIs of claim 1, wherein the RYIs are determined on an end-of-day basis.

8. A computerized investment method to create on a real time basis, Roll Yield Indexes (“RYI”), and to rebalance on a periodic basis the RYI, comprising:
a computer processor;
a computer memory database; and
real time commodity price feed information;
wherein the RYI is calculated using the following algorithm:
$$R Y {I}_{t , i} = R Y {I}_{t - 1 , i} + R Y {I}_{t - 1 , i} * {\sum }_{k = 1}^{{N}_{i}} ( {w}_{t - 1 , i , k} * \frac{{P}_{t , i , k}}{{P}_{t - 1 , i , k}} ) , t > 0$$
where RYI_{t,I}=Roll Yield Index for the ith commodity at time t; w_{t-1,i,k}=weight of the ith commodity at time t for contract k; P_{t,i,k}=price of the ith commodity at time t for contract k; and Nᵢ=number of contracts for commodity I; and further
wherein the dollar-neutral net asset value (“NAV”) rebalancing of the RYI, on a “t” frequency for all t>0, is determined using the following algorithm:
NAVxyt*M*[1+(Xt+1÷Xt)−(Yt+1÷Yt)],NAVxyt+1*M*[1+(Xt+2÷Xt+1)−(Yt+2÷Yt+1)],NAVxyn*M*[1+(Xn÷Xn-1)−(Yn÷Yn-1)]
where Xt=absolute value of Index X at NAV calculation time t; Yt=absolute value of Index Y at NAV calculation time t; M=Multiplier or Leverage Factor, M NAVxyt=Net Asset Value of Long Short Portfolio XY at Time t; and “t” can be defined as 1 or more days (i.e., 2 days, 1 week, 1 month, or 1 year).

9. The computerized investment method of claim 8 to create and rebalance Roll Yield Indexes, wherein the method is used to design and create an end-of-time period RYI.

10. The computerized investment method of claim 8 to create and rebalance Roll Yield Indexes, wherein t is less than or equal to 1 month.

11. The computerized investment method of claim 8 to create and rebalance Roll Yield Indexes, wherein t is less than or equal to 1 year.

12. The computerized investment method of claim 8 to create and rebalance Roll Yield Indexes, wherein t is greater than 1 year.

13. The computerized investment method of claim 8 to create and rebalance Roll Yield Indexes, wherein Nᵢ=2.

14. The computerized investment method of claim 8 to create and rebalance Roll Yield Indexes, wherein N₁ is greater than 2.

15. The computerized investment method of claim 8 to create and rebalance Roll Yield Indexes, wherein the leverage factor is 2, or M=2.
